(19) United States
(12) Patent Application Publication
(10) Pub. No.: US 2021/0342412 A1
(43) Pub. Date: Nov. 4, 2021

(54) SYSTEMS AND METHODS FOR INITIATING PERSONALIZED MEDIA

(71) Applicant: Beyondant, LLC, New York, NY (US)

(72) Inventors: Marc Glenn Sussman, Cooper City, FL (US); Ben Billy Boulet, Southwest Ranches, FL (US); Marc Scott Rubin, Weston, FL (US); Steve Dumont, Coral Springs, FL (US)

(21) Appl. No.: 17/171,862

(22) Filed: Feb. 9, 2021

Related U.S. Application Data
(60) Provisional application No. 63/018,046, filed on Apr. 30, 2020.

(51) Int. Cl. G06F 16/9538; G06F 3/0481

(52) U.S. Cl. CPC G06F 16/9538; G06F 3/0481

(57) ABSTRACT

A system and method for initiating personalized media. The system includes a provider tag affixed to a provider object including a unique provider identifier. The system further includes a network interface device communicatively coupled to a communications network configured to support computing devices with retrieving information associated with the provider tag and generating personalized media presentations associated with the provider object configured to be presented on visual displays connected to the communications network.

### CROSS-REFERENCE TO RELATED APPLICATIONS

The present U.S. Utility Patent Application claims priority pursuant to 35 U.S.C. § 119(e) to U.S. Provisional Application No. 63/018,046 entitled “SYSTEMS AND METHODS FOR INITIATING PERSONALIZED MEDIA ASSOCIATED WITH A LOVED INDIVIDUAL”, filed Apr. 30, 2020, which is hereby incorporated herein by reference in its entirety and made part of the present U.S. Utility Patent Application for all purposes.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

Not Applicable.

### TECHNICAL FIELD

The disclosed embodiments relate generally pertains to initiating personalized media. In particular, but not by way of limitation, the present technology provides systems and methods for generating and sharing personalized media using communication protocols.

### BACKGROUND

Society is currently shifting into a minimal physical contact culture resulting in low-touch and/or touch-free technologies becoming more in demand than ever. As a result, various components of everyday life that have historically been performed in person are now shifting to the virtual realm. On one hand, this shift is the most feasible approach to ensure the welfare of the general public by reducing the probability of harmful viruses, bacteria, and/or germs becoming rampant. On the other hand, the shift eliminates authentic social components traditionally inherent to business practices on both a micro and macro level. For example, components inherent to in-person networking such as shaking hands and exchanging business cards may serve as a source for distributing harmful viruses, bacteria, and/or germs; however, exchanging business cards remains a crucial component of networking and business development overall. An alternative solution is to rely solely on internet-based social networking services such as LinkedIn, Meetup, Xing, and other applicable services in order to professionally network and subsequently generate and capitalize on leads. However, this approach not only eliminates the physical interpersonal components of networking, but also reduces the ability to analyze an individual's ability to adapt to various environments and circumstances due to the strictly virtual presentation of someone.

In addition to the reduction of authentic networking interactions, the shift to the integration of low-touch and/or touch-free technologies alters the methods of how individuals congregate in social settings. Practices, such as social distancing, create hurdles for individuals to not only congregate, but also disseminate traditional mediums for spreading general information and advertising, such as pamphlets, brochures, or any other tangible form of information. For example, historically during a funeral or memorial service, the host passes out obituaries containing information relating to the deceased individual. Not only is this practice becoming obsolete in light of the shift into a minimal physical contact culture, but it also prevents any sharing of customized or personalized memorabilia relating to the deceased that an individual attending the ceremony would like to share.

Therefore, there exists a need for improvements over the prior art and more particularly for a more efficient way to generate and share personalized media that conforms to the evolving minimal physical contact culture.

### SUMMARY

This Summary is provided to introduce a selection of disclosed concepts in a simplified form that are further described below in the Detailed Description, including the drawings provided. This Summary is not intended to identify key features or essential features of the claimed subject matter. Nor is this Summary intended to be used to limit the claimed subject matter's scope.

In one embodiment, a system for initiating personalized media is disclosed. The system comprises a communications network for providing media comprising: a provider tag, the provider tag configured to transmit a provider tag signal having a provider unique identifier; a provider object for housing the provider tag; a database for storing a provider record for each of a plurality of providers; a memory; a network interface device communicatively coupled with the communications network; and, a processor configured for: providing, to a provider computing device, a provider interface for receiving a plurality of provider data, wherein the provider data includes at least a unique provider identifier associated with the provider; receiving, from the provider computing device, the plurality of provider data; creating the provider record for each of the plurality of providers; storing the provider data in its associated provider record; receiving, from the provider computing device, provider informative subject data on a subject; storing, in the provider record the provider tag identifier associated with the provider tag; receiving, from a user computing device, a user request for provider informative data, wherein the user request for provider informative site data is automatically transmitted after the user computing device detects the provider tag signal having the provider unique identifier; determining the provider record associated with the provider tag identifier received from the user computing device; and, providing, over the communications network, to a graphical user interface of the user computing device, at least one media content associated with the provider informative subject data.

In one embodiment, a method for initiating personalized media is disclosed. The method comprising providing, to a provider computing device, a provider interface for receiving a plurality of provider data, wherein the provider data includes at least a unique provider identifier associated with the provider; receiving, from the provider computing device, the plurality of provider data; creating the provider record for each of the plurality of providers configured to be stored in a provider record database; storing the provider data in its associated provider record; receiving, from the provider computing device, provider informative subject data on a subject; storing, in the provider record, the unique provider identifier; wherein the unique provider identifier is associated with a provider tag configured to transmit a provider tag signal; providing, to a user computing device, a user interface for receiving a plurality of user data, wherein the user computing device is configured to detect a provider tag signal when the user computing device is within a predetermined proximity of the provider tag; receiving, from the user computing device, user data associated with the user; creating a user record; storing, in the attached database, the user data associated with the user in the user record; receiving, from the user computing device, a user request for provider informative data, wherein the user request for provider informative site data is automatically transmitted after the user computing device detects the provider tag signal having the provider unique identifier; determining the provider record associated with the provider unique identifier received from the user computing device; and, providing, over the communications network, to a graphical user interface proximate with the user, at least one media content associated with the provider informative subject data.

To the accomplishment of the above and related objects, this invention may be embodied in the form illustrated in the accompanying drawings, attention being called to the fact, however, that the drawings are illustrative only, and that changes may be made in the specific construction illustrated and described within the scope of the appended claims. The foregoing and other features and advantages of the present invention will be apparent from the following more particular description of the preferred embodiments of the invention, as illustrated in the accompanying drawings.

### BRIEF DESCRIPTION OF THE DRAWINGS

The accompanying drawings, which are incorporated in and constitute part of this specification, illustrate embodiments of the invention and together with the description, serve to explain the principles of the disclosed embodiments. The embodiments illustrated herein are presently preferred, it being understood, however, that the invention is not limited to the precise arrangements and instrumentalities shown, wherein:

FIG. 1 is a diagram of an operating environment that supports the applications, systems and methods for initiating personalized media, according to a first example embodiment;

FIG. 2A is a block diagram illustrating an exemplary system for initiating personalized media, according to an example embodiment;

FIG. 2B is a block diagram illustrating an exemplary data flow associated with the system for initiating personalized media, according to an example embodiment;

FIG. 3 is a block diagram illustrating an exemplary data flow associated with the system for initiating personalized media, according to an example embodiment;

FIG. 4 is a block diagram illustrating an exemplary method for initiating personalized media, according to an example embodiment; and

FIG. 5 is an illustration depicting an exemplary interface presented on a computing device of the system for initiating personalized media, according to an example embodiment;

FIG. 6 illustrates a computer system according to exemplary embodiments of the present technology.

### DETAILED DESCRIPTION

The following detailed description refers to the accompanying drawings. Whenever possible, the same reference numbers are used in the drawings and the following description to refer to the same or similar elements. While disclosed embodiments may be described, modifications, adaptations, and other implementations are possible. For example, substitutions, additions, or modifications may be made to the elements illustrated in the drawings, and the methods described herein may be modified by substituting reordering or adding additional stages or components to the disclosed methods and devices. Accordingly, the following detailed description does not limit the disclosed embodiments. Instead, the proper scope of the disclosed embodiments is defined by the appended claims.

The disclosed embodiments improve upon the problems with the prior art by providing a system and method for initiating personal media circumventing the need for individuals to come within close proximity of each other to share content in real time. The present embodiment improves over the prior art by providing mechanisms to automatically detect tags disposed on various objects and extract pluralities of information associated with said tags and objects without requiring direct contact with computing devices receiving the pluralities of information. The present embodiment utilizes the computing devices receiving the pluralities of information to personalize the pluralities of information in order to generate a media content configured to be transmitted to a computing device operating on a local area network. Additionally, the present embodiment is configured generate continuously updated real time data streams including optimized tag-specific data configured to be output on computing devices. Furthermore, the disclosed embodiments provide systems and methods for initiating personalized media associated with a loved individual. The claimed subject matter improves over the prior art by providing a unique way for consumers to bridge themselves with loved individuals via the personalized media.

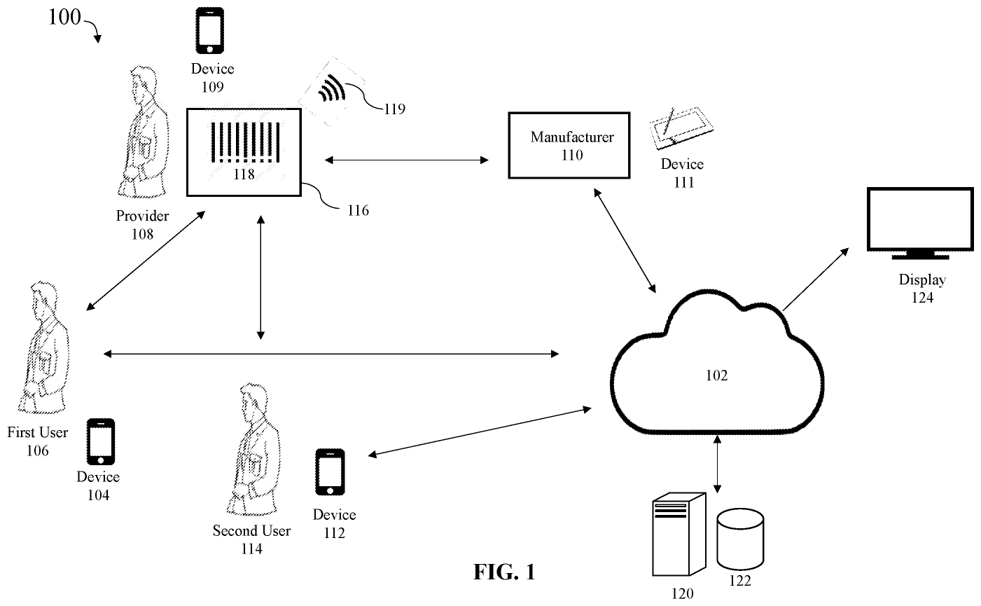

Referring now to FIG. 1, an operating environment 100 that supports the systems and methods for initiating personalized media is depicted. Environment 100 comprises a communications network 102, a first user computing device 104 associated with a first user 106, a provider 108 associated with a provider tag 118 that is affixed to a provider object 116, a provider device 109 that may be associated with the provider, a manufacturing entity 110 associated with a manufacturing entity computing device 111, and a second user computing device 112 associated with a second user 114. Each of first user computing device 104, second user computing device 112, provider device 109, and manufacturing entity computing device 111 are communicatively coupled to network 102. Provider 108 may be associated with (e.g., communicate with via provider device 109) one or more computing devices. Each of the computing devices 104, 112, 109, 111 of environment 100 are configured to gain convenient high-speed access to networks, such as network 102, which may be, for instance, a wireless local area network (WLAN).

In one embodiment, manufacturer 110 is configured to manufacture one or more chips, processors, or any other applicable components configured to be directly associated with provider tag 118. In one embodiment, manufacturer 110 designs and configures said components to enable provider tag 118 to be directly associated with provider 108 or provides a mechanism, such as an application comprising a provider user interface for display on a provider device 109 that supports provider 108 controlling content associated with provider tag 118. In one embodiment, provider 108 and manufacturer 110 may be the same entity and be further configured to have information of provider 108 preloaded and associated with provider tag 118. It is to be understood that provider tag 118 is configured to be associated with provider 108 and further configured to be a source to access information associated with provider 108, such as provider informative subject data, based on information provided by manufacturer 110 (via computing device 111) and/or provider 108 directly.

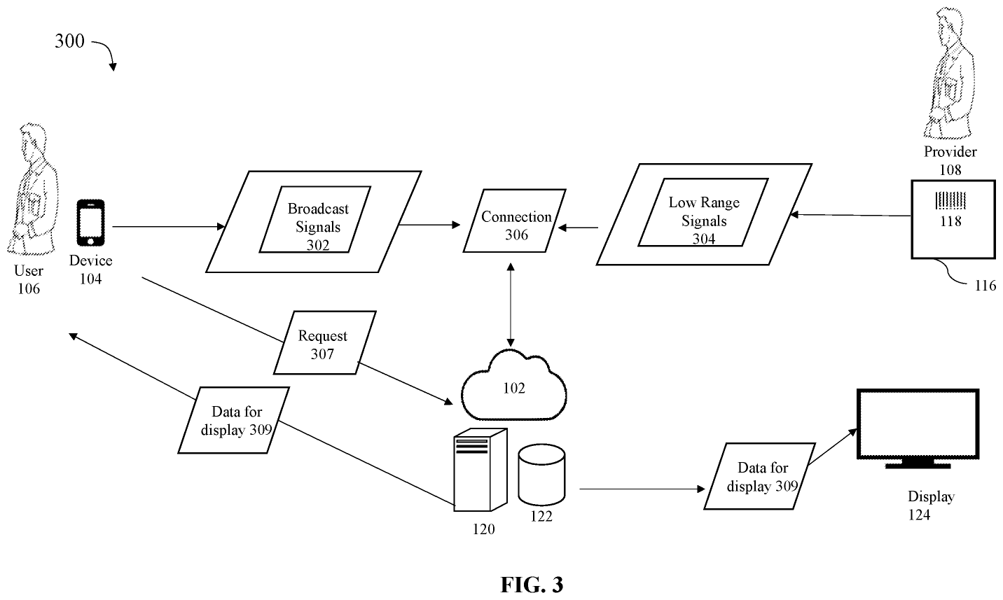

In one embodiment, provider object 116 is configured to house provider tag 118, thereby allowing provider tag 118 to transmit and/or broadcast one or more low range provider tag signals 119. This will be explained in greater detail during discussion of FIG. 3. In one embodiment, provider tag 118 comprises a unique provider identifier configured to be detected via computing devices 104 and 112 which are configured to generate magnetic fields in search of the provider tag signals 119 in order to associate, analyze, and subsequently retrieve pluralities of data specific to provider 108, such as provider informative subject data.

Environment 100 further comprises one or more servers 120 in addition to an associated database 122, in which server 120 comprises at least a processor configured to support server 120 to function as a network interface communicatively coupled to network 102 and perform the methods of initiating personalized media as provided throughout the disclosure. In one embodiment, server 120 in combination with network 102 provides a provider interface on user device 109 configured to be communicatively coupled to network 102, in which the provider interface is configured to receive a plurality of provider data comprising a unique provider identifier in addition to provider specific data associated with users 106 & 114 and provider 108. In one embodiment, the provider interface may be a graphical user interface displayed on remote computing device 109. The provider interface may also include a graphical user interface in the form of a webpage etc.

Database 122 is designed and configured to store data associated with provider 108, provider tag 118, and any other computing device operating 104, 106, 111 in environment 100, such as user records comprising pluralities of user data associated with users 106 & 114. Database 122 is continuously accessed by server 120 in order to perform media content generation functions along with coordination of data transmissions accomplished via utilization of network 102. It is to be understood that provider specific records comprising provider specific data relating to provider 108 are stored in database 122 and accessed based on the unique provider identifier associated with provider tag 118, in which in certain embodiments the provider tag identifier may be accessed via a QR code, a barcode, a Microsoft code, a near-field communication (NFC) chip, sticker, RFIDs, Bluetooth, Zigabee, WiFi, or any other mechanism configured to serve as a source for contactless transmission of data based upon factors such as context, proximity, and others. In one embodiment, server 120 is configured to create user records stored on database 122 comprising the pluralities of user data associated with users 106 & 114. As described herein, user data may comprise, but is not limited to, user first and last name, user email, user phone number, and other applicable user information. The user data may also include the user personalized media 222 further explained below.

In one embodiment, the data record associated with provider 108 is provided data directly from manufacturer 110 and/or provider 108 via a centralized platform such as a software application configured to function on a computing device. Once a connection has been established between computing devices 104 & 112 and provider tag 118 (as will be described in greater detail referring to FIG. 3), server 120 responds by accessing the provider record associated with provider object 116 based on the unique provider identifier. It is to be understood that provider informative subject data may be any type of data associated with provider 108 and is subject to the type of entity that provider 108 is. For example, if provider 108 is a historic site, such as a monument or national park, then provider informative subject data may relate to a wide range of facts associated with the monument or national park configured to be presented to computing devices 104 & 112 based on detecting provider tag signals 119.

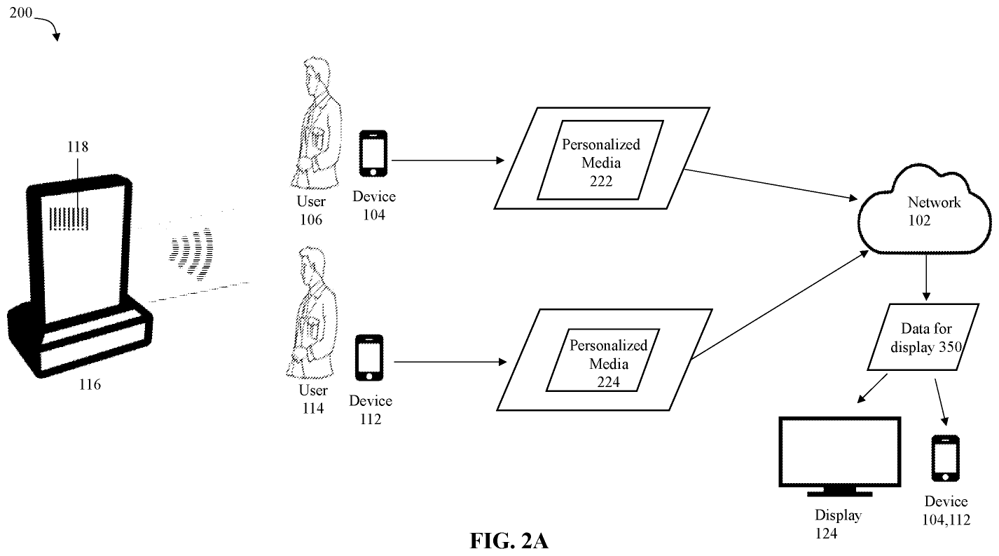

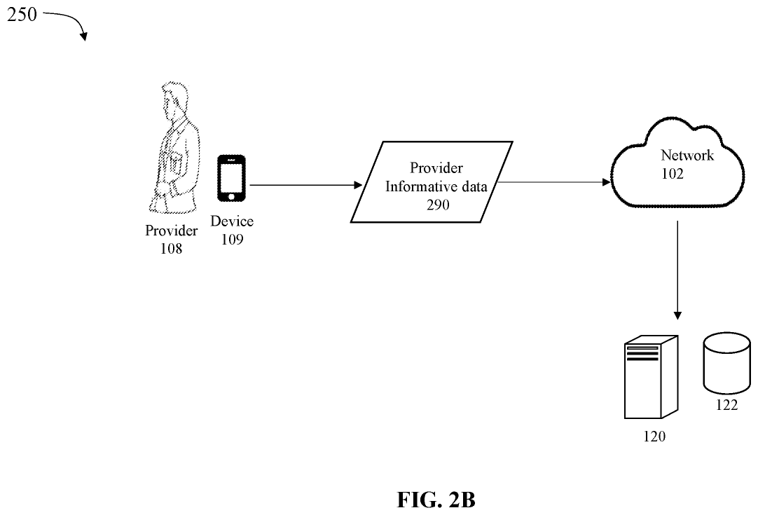

In other embodiments, as illustrated in FIG. 2B, the provider may use provider device 109 to provider informative subject data 290 associated with the subject. As mentioned above, the subject may include the provider as well as other objects or subjects not associated with the provider. For example, a historic site, such as a monument or national park, a person, a loved one etc. The provider informative subject data may include data or audio or visio content associated with the subject etc.

As described herein, provider data is any plurality of data associated with provider 108 including the unique provider identifier; however, provider data may be data supplied by provider 108 associated with provider specific configurations/settings indicating which provider informative subject data may be provided to computing devices 104 & 112 based on data associated with the requesting user. For example, in the instance where provider 108 is a national park, server 120 may detect based on metadata associated with computing device 104 that user 106 is a hiker and present to computing device 104 information associated with hiking trails relating to the national park once computing device 104 detects provider tag 118 via provider tag signals 119. Provider may include the provider, name, email address, other identifying information, audio and visual content data, provider preferences, provider age, provider physical address. It is understood that other provider data may also be used and is associated with the present invention.

User 106 accesses the information associated with the hiking trails and may upload live and/or digital content, such as videos and pictures of user 106 hiking the trails, in which server 120 associates the content with provider 108 and user 106 has the option of presenting the content to display 124. In one embodiment, display 124 is an auxiliary computing device comprising an interface configured to display content once provider tag signals 119 are detected within a certain proximity to computing device 104 or 114.

In one embodiment, computing device 104 includes but is not limited to a mobile phone, tablet, smart phone, smart tv, application, over-the top media service (OTT), streaming platform, desktop, laptop, wearable technology (smartwatch), or any other applicable device or system comprising at least a processor. In one embodiment, visual display 124 is a television, projector, or any other applicable mechanism used for visual and audio presentation of content sourced from a wireless network, such as network 102. In one embodiment, server 120 may provide the aforementioned centralized platform manifested via an executable software (application) hosted over network 102 in which user 106 may acquire data associated with provider 108 via one or more interactions between computing device 104 and provider tag 118.

It is to be understood that provider 108 as described herein may be considered a source, entity, or subject in which provider object 116 and provider tag 118 is directly or indirectly associated with. In one embodiment, provider tag 118 is inscribed, etched, engraved, affixed via an adhesive mechanism, or any other applicable form of sustainable attachment configured to endure force and pressure applied by natural and/or unnatural sources (rain, wind, human interaction, etc.) to a surface of provider object 116. For example, in the case where provider 108 is a memorial management entity and provider object 116 is a tombstone or memorial associated with a deceased individual or an artifact registered under the memorial management entity comprising the provider tag 118 inscribed on a surface of provider object 116, computing device 104 may automatically detect provider tag 118 via a proximity based mechanism such as near field communication resulting in the computing device sending a request to server 120 via network 102 to access the provider record associated with the decease individual stored in database 122 based on the provider unique identifier. In this working example, server 120 extracts the information from the provider record and transmits the information to either a software platform associated with the memorial management entity or the centralized platform generated by server 120 for presentation on computing device 104. In one embodiment, the memorial management entity may be a component of the centralized platform in which server 120 is configured to present a real-time data stream associated with provider 108 in addition to adding data associated with user 106 in association with provider 108 allowing presentation of a continuously updated data stream/news stream associated with provider 108 depicted on visual display 124.

Referring now to FIG. 2A, a system for initiating personalized media 200 is depicted according to an example embodiment. It is to be understood that the transmission and presentation of personalized media is accomplished once a connection is established between the NFC chip and the applicable computing device seeking to transmit the personalized media. In one working example, users 106 and 114 each are attendants at a funeral repass service in which the setting of the service comprises at least provider tag 118 associated with the deceased individual disposed in a discoverable location within the venue, such as inscribed on provider object 116. In one embodiment, server 120 may be initially presenting information relating to the deceased individual to visual display 124, such as a biography, eulogy, images of the deceased individual, or any other applicable multimedia associated with the deceased individual. Users 106 and 114 may contribute personalized media associated with the deceased individual via inputs provided to and/or sourced from computing devices 104 and 112; in which said inputs may be provided directly to the centralized platform or server 120 may request users 106 and 114 to contribute personalized media associated with the deceased individual based on server 120 detecting that devices 104 and 112 have interacted with provider tag 118 via provider tag signals 119. For example, user 106 provides first personalized media 222 sourced from computing device 104 and user 114 provides second personalized media 224 sourced from computing device 112, each personalized media configured to be associated with provider 108 comprising media content relating to provider 108. It is to be understood that personalized media may be media content that associates the user to the deceased individual and is configured to be displayed on visual display 124 via a live streaming feed of media content associated with the deceased individual. The live streaming feed is configured to be continuously updated with personalized media content provided by users that are within proximity of provider tag 118 sourced from their respective computing devices in which the live streaming feed is depicted directly on visual display 124 resulting in an entertaining experience displaying user content and associated media content. In one embodiment, personalized media content may also be sourced from sources not physically in attendance (such as individuals virtually attending the repast) via one or more live stream channels made available by network 102 configured to be depicted in the live streaming feed presented on visual display 124.

Examples of personalized media may include, but is not limited to, pictures uploaded by the user of the deceased individual, 150 maximum character condolences, applicable music, videos/home videos, and any other applicable memorabilia configured to be presented on visual display 124 via the continuous live data stream. It is to be understood that various forms of server 120 collecting memorabilia data from devices 104 and 112 and presenting the collected memorabilia on visual display 124 are within the spirit and scope of the claimed embodiments. In one embodiment, the live streaming feed is configured to be presented directly on computing devices 104 & 112.

In one embodiment, provider object 116 may be a business card, a memorial wall, memorial bench, picture frame, fountain, wearable jewelry, bracelet, pendent, memorial furniture piece, memento, or any other applicable surface configured to comprise provider tag 118. While object 116 does not embody the above-mentioned objects is understood that above objects may we included and are within spirit invention.

It is to be understood that provider object 116 is configured to comprise at least one of the aforementioned mechanisms of contactless transmission of data embedded therein (directly associated with provider tag 118), such as a NFC chip, in order for computing device 104 to be able to detect provider tag 118. In application, once computing device 104 detects provider tag 118, server 120 extracts a plurality of information associated with provider object 116 and/or provider 108 if a provider record currently exists, creates a provider record if one does not already exist for provider 108, and stores the plurality of information associated with provider 108 in the provider record in database 122. In one embodiment, the centralized platform may be configured to be continuously updated with information acquired from both new and existing provider objects in which data associated with the provider object accessed by the aforementioned mechanisms of contactless transmission of data is continuously updated and stored in database 122. Therefore, if computing device 104 comes within the proximity of provider object 116 that is not registered with system 200, then obtainable data associated with provider object 116 may be extracted by server 120 or data may be manually inputted by provider 108. In a preferred embodiment, provider object 116 comprises at least a uniquely identifiable chip with provider tag 118 disposed thereon comprising at the lead entity name and the lead entity contact information (email, phone number, website, etc.). In application, computing device 104 (already being registered to the centralized platform) detects the uniquely identifiable chip of provider 108 not within the centralized platform based on a predefined proximity, and server 120 is triggered to extract at least the business card entity name and contact information (email, phone number, etc.), store the extracted data within a provider record, and assign a unique provider identifier to the provider record. It is to be understood that the provider records may be utilized directly by the centralized platform operated by server 120 or exported to third party entities, such as LinkedIn, Meetup, Xing, etc., in order to support the generation and maintenance of accounts on the applicable professional networking platforms. For example, the user of computing device 104 (already being registered to the centralized platform) wishes to connect with an individual within a physical proximity that conforms to social distancing standard. The user utilizes computing device 104 to transmit a plurality of signals in order to discover the uniquely identifiable chip of provider object 116 based on the proximity of computing device 104 to an NFC tag disposed on provider object 116 and since server 120 does not detect an applicable provider record, provider 108 and/or manufacturer 110 may be prompted via server 120 or the applicable networking platform for the information that will be stored in the generated provider record. Server 120 searches for the provider record of the provider object 116 based on the unique provider identifier associated with provider tag 118 and based on the results of the search, server 120 can determine whether or not the individual associated with provider object 116 has a profile on the centralized platform and/or aforementioned professional networking platforms.

Although provider object 116 is depicted as a memorial in FIG. 2A, provider object 116 may be, but is not limited to, a headstone, tomb, obituary, pamphlet, business card, wristband/apparel, matchbox, or any other item configured to comprise at least a planar surface shaped and sized to fit an inscribed or affixed provider tag 118. Provider tag 118 may be shaped, sized, and allocated in various arrangements that allow easy detection by computing devices 104 and 112, such variations are within the spirit and scope of the claimed invention. It is to be understood that in a preferred embodiment provider tag 118 is a NFC tag configured to function as a passive entity that operates without a power supply that relies on computing devices 104 and 112 to come within a predetermined proximity in order to be activated. In one embodiment, provider tag 118 is configured to utilize electromagnetic induction in order to create current allowing the surface comprising the NFC tag (provider object 116) to function as a passive device via the generated current powering the circuitry.

In one embodiment, provider object 116 is manifested in the form of wearable technology such as a bracelet configured to comprise a chip serving as the source for provider tag 118. In one working example, computing devices 104 and 112 transmit signals searching for provider tag 118 located on the bracelet, and once detected computing devices 104 and 112 receive (via each respective graphical user interface) information associated with the chip comprising a business name, a method of contact for said business, and any other applicable marketing information sourced from server 120 accessing database 122 based on the unique provider identifier.

Referring now to FIG. 3, a data flow 300 associated with the system for initiating personalized media is depicted, according to an example embodiment. In one embodiment, computing device 104 transmits a plurality of broadcasting signals 302 in search of a plurality of low range signals 304 being emitted from provider tag 118. Once the broadcast signals detect the low range signals, a connection 306 is formed between the active device (computing device 104) and the passive device (a chip associated with provider tag 118). The connection may be the connection that is typically formed when an NFC device within a certain geographic distance with a computing device. Next, device 104 sends a request and/or query 307 for information associated with the unique ID of provider tag 118. In one embodiment, server 120 is configured to detect connection 306 directly instead of receiving a request from the device. In one embodiment, the request is automatically triggered to access the provider record stored within database 122 based on the unique provider identifier associated with provider tag 118. In one embodiment, after receiving the request, the provider informative subject data 290 is automatically transmitted by server 120 after connection 306 is made.

It is to be understood that server 120 performs the aforementioned functions based off of connection 306 being established; however, server 120 may be actively prepared to access the provider record associated with provider 108 by transmitting the data once there is a detection of broadcast signals 202 and low range signals 204. For example, server 120 may be able to detect that user 106 is within a threshold proximity to provider tag 118 and issue a prompt to computing device 104 for interaction with system 200 prior to connection 306 being established. In other embodiments, when devices are within a certain distance that establishes connection 306 between passive and active devices, computing device 104 automatically instructs server 120 to send request 307 to access database 122 in search of the provider record based on one or more discoverable components associated with provider tag 118, such as the unique provider identifier. For example, computing device 104 may be able to detect that provider tag 118 is within six feet of computing device 104, then computing device 104 will instruct server 120 to query database 122 in search of the provider record associated with provider 108 based on the unique provider identifier. It is to be understood that environment 100 is configured to provide various functionalities, in particular environment 100 provides communication protocols (NFC, RFID, beacons, etc.) to establish interactions between computing device 104 and provider tag 118 all of which may be supported by network 102.

In one embodiment, in response to the request 307, server 120 accesses the provider record based on the unique identifier associated with provider tag 118 derived from provider tag signals 119, resulting in server 102 transmitting a plurality of data for display 309 associated with provider 108 to user 106 via computing device 104 or directly to display 124. It is also understood that the system in one embodiment is configured to sin the provider record the provider tag identifier associated with the provider tag;

It is to be understood that data received from computing device 104 in order to generate personalized media 222 may be subject to approval/denial by provider 108 based upon the context. For example, provider 108 may indicate that the personalized media that the user is attempting to upload is inapplicable or inappropriate, in which server 120 prevents the plurality of data for display 309 from being presented and informs the user accordingly. Otherwise, server 120 generates personalized media 222 into a format suitable for display, and the plurality of data for display 309 is transmitted to display 124 or computing device 104 depending upon the configuration. In one embodiment, the plurality of data for display 309 is continuously being presented to display 124 or computing device 104 allowing users who have established connection 306 to have access to provider informative subject data which is configured to be volatile. For example, provider 108 may be continuously contributing data to the plurality of data for display 309 allowing presentation of the plurality of data for display 309 to vary based upon who is receiving it. For example, the plurality of data for display 309 may continuously present various facts associated with provider 108 to computing device 104 and/or display 124.

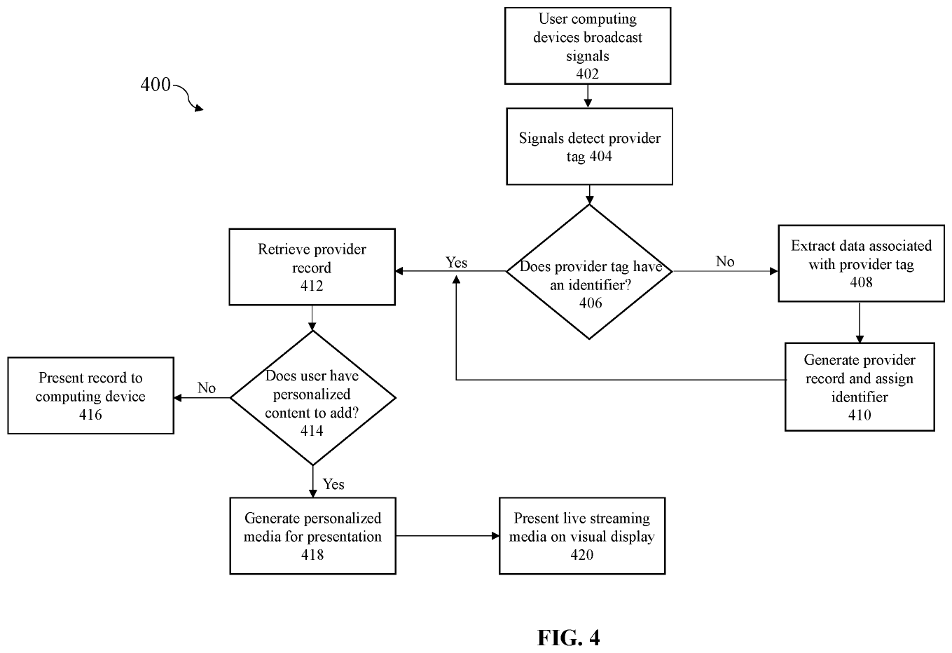

Referring now to FIG. 4, an exemplary method for initiating personalized media 400 is depicted, according to an example embodiment. At step 402, computing device 104 actively broadcasts plurality of signals 302 in an attempt to search for provider tag 118 via low range signals 304 being emitted. In one embodiment, the predefined proximity is based upon the configuration of the environment housing provider object 216. At step 404, computing device 104 detects provider tag 118 and connection 306 is formed. At step 406, with the computing devices now having one or more interactions with provider tag 118, server 120 determines if there is a unique provider identifier associated with provider tag 118. If provider tag 118 does not comprise a unique provider identifier, then this indicates that provider object 116 and/or provider 108 is not registered within the system and there is not at least a name and means of contact associated with said name relating to provider 108. At step 408, server 120 extracts at least a name and means of contact associated with said name. However, depending upon the configuration of the system, this extracted information must be collected manually via provider 108 and/or manufacturer 110 or in one embodiment, computer vision and machine learning techniques may be utilized by server 120 in order to extract said information. For example, the name and contact information of provider 108 and/or provider object 116 may be acquired via one or more sensors (cameras) associated with the environment housing provider object 116 in which computer vision and machine learning techniques are utilized to perform analysis on captured images containing provider object 116 in order to extract the necessary information. At step 410, the extracted information is utilized by server 120 to generate a provider record for the unknown provider tag 118 and a unique provider identifier is assigned. If provider tag 118 comprises an associated unique provider identifier, then step 412 occurs in which server 120 accesses the provider record based on the unique provider identifier. At step 414, server 120 makes a determination as to whether user 106 wish to contribute personalized media associated with provider object 116 and/or provider 108. In one embodiment, this determination is made based upon step 416 occurring in which provider record comprising information associated with provider object 116 is presented to computing device 104 and user 106 is provided the opportunity to upload personalized media 222. In one working example, user 106 desires to upload a picture of himself and the deceased individual associated with provider object 116 and user 114 desires to add a song reminiscent of the deceased individual to a queue associated with the live streaming feed of media content associated with the deceased individual. At step 414, while each respective user is interacting with server 120, communications are being transmitted between computing devices 104 and 112 via network 102. At step 418, server 120 generates the personalized media of each respective user based on the inputs received on interfaces associated with their respective computing device. At step 420, server 120 transmits the generated personalized media to visual display 124 in real-time resulting in a continuous stream of data associated with the deceased individuals to be presented. In one embodiment, the current live stream media associated with provider 108 depicted on visual display 124 incrementally integrates personalized media 222 and personalized media 224 into the live stream media allowing server 120 to integrate new data associated with provider 108 into the live stream for presentation on visual display 124.

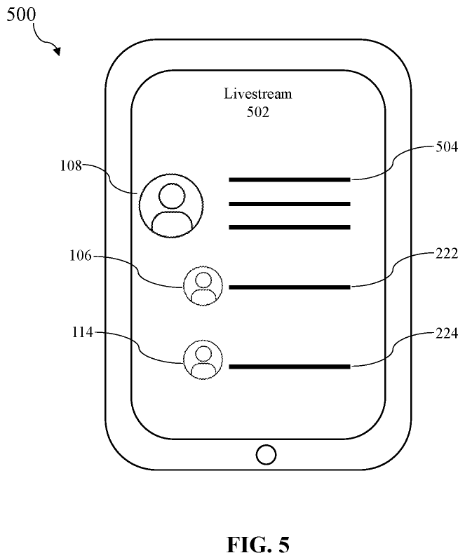

Referring now to FIG. 5, an exemplary illustration of an entertaining experience presentation 500 associated with system 200 is depicted. In one embodiment, entertaining experience presentation 500 comprises a livestream 502 comprising a plurality of provider informative subject data 504 associated with provider 108. As illustrated, livestream 502 continuously receives a plurality of real-time inputs, at least provider data associated with provider 108, and personalized media 222 and 224 depicted aligned with the applicable source. In one embodiment in which computing device 104 receives the plurality of data for display 309, the plurality of real-time inputs are touches, motions, or gestures of user 106 on computing device 104 resulting in livestream 502 being scrolled through. For example, user 106 can scroll in the opposite direction that livestream 502 is being continuously depicted in resulting in user 106 being able to view personalized media that was presented prior to them providing personalized media 222. If user does not provide the plurality of real-time inputs then livestream 502 will continue to automatically scroll continuously adding content provided by subsequent users, such as personalized media 224 provided by user 114, while still displaying the plurality of provider informative subject data 504 in a stationary manner. In one embodiment, the plurality of provider informative subject data 504 is incrementally updated with new information associated with provider 108 based upon one or more metrics associated with the amount of user interaction with livestream 502. In certain embodiments, the entertaining experience may be configured to include the media content associated the provider informative data as well as personalized content 222, 224 associated with one of more uses. The present embodiment allows the users of the system to automatically view media associated with data provided by the provider and by the user and other uses of the system when the user's device is within a predetermined distance of provider tag 118. For example, in one embodiment, a user 106 having a device 104 may come into close proximity with an object having a provider tag 118. In one embodiment, as a result of the device 104 being within close proximity of the object 116, a connection 306 is made. In one embodiment after the connection is made, user device sends a user request 307 for provider informative data. Additionally, as illustrated in FIG. 2A, after the connection is made, device 104 may also transit personalized media 222 associated with the particular user number 106. The personalized media may include photos, data, as well as other information associated with the particular subject. Personal media may include data including text, SMS messages, audio content, visual content, haptic content. However, other types of content may also use used and is within the spirit and scope of the present invention. In certain embodiments, the subject may be the provider 108 or the object 116. For example, in certain embodiments, the system may be configured for receiving data via a graphical user interface presented on the user device 104 configured for receiving data, such as text, audiovisual content associated with the object. For example, if the object is a business card of a person, then the personalized media that may be provided by the user via the user interface displayed on device 114 may include photos, notes or other information associated with person associated with that business card.

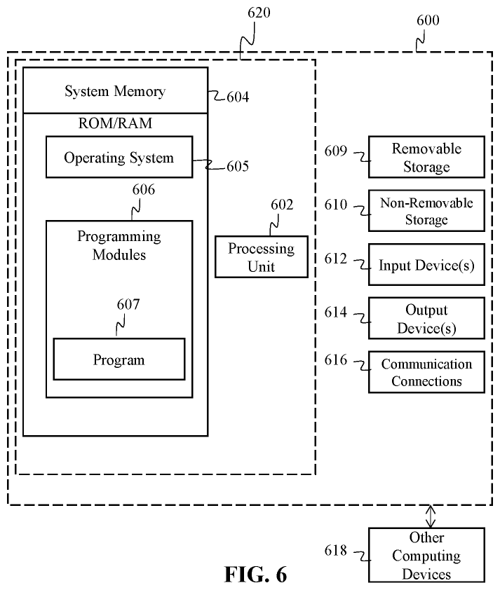

FIG. 6 is a block diagram of a system including an example computing device 600 and other computing devices. Consistent with the embodiments described herein, the aforementioned actions performed by system 200 may be implemented in a computing device, such as the computing devices 104, 109, 111, 112, 124, 120, 122. Any suitable combination of hardware, software, or firmware may be used to implement the computing devices 104, 109, 111, 112, 124, 120, 122. The aforementioned system, device, and processors are examples and other systems, devices, and processors may comprise the aforementioned computing device. Furthermore, computing devices 104, 109, 111, 112, 124 may comprise an operating environment for system 200. Processes, and data related to system 200 may operate in other environments and are not limited to computing devices 104, 109, 111, 112, 124.

A system consistent with an embodiment of the invention may include a plurality of computing devices, such as a computing device 600 of FIG. 6. In a basic configuration, computing device 600 may include at least one processing unit 602 and a system memory 604. Depending on the configuration and type of computing device, system memory 604 may comprise, but is not limited to, volatile (e.g. random access memory (RAM)), non-volatile (e.g. read-only memory (ROM)), flash memory, or any combination or memory. System memory 604 may include operating system 605, and one or more programming modules 606. Operating system 605, for example, may be suitable for controlling computing device 600's operation. In one embodiment, programming modules 606 may include, for example, a program module 607 for executing the actions of system 200 for example. Furthermore, embodiments of the invention may be practiced in conjunction with a graphics library, other operating systems, or any other application program and is not limited to any particular application or system. This basic configuration is illustrated in FIG. 6 by those components within a dashed line 620.

Computing device 600 may have additional features or functionality. For example, computing device 600 may also include additional data storage devices (removable and/or non-removable) such as, for example, magnetic disks, optical disks, or tape. Such additional storage is illustrated in FIG. 6 by a removable storage 609 and a non-removable storage 610. Computer storage media may include volatile and nonvolatile, removable and non-removable media implemented in any method or technology for storage of information, such as computer readable instructions, data structures, program modules, or other data. System memory 604, removable storage 609, and non-removable storage 610 are all computer storage media examples (i.e. memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 600. Any such computer storage media may be part of system 600. Computing device 600 may also have input device(s) 612 such as a keyboard, a mouse, a pen, a sound input device, a camera, a touch input device, etc. Output device(s) 614 such as a display, speakers, a printer, etc. may also be included. The aforementioned devices are only examples, and other devices may be added or substituted.

Computing device 600 may also contain a communication connection 616 that may allow system 200 to communicate with other computing devices 618, such as over a network in a distributed computing environment, for example, an intranet or the Internet. Communication connection 616 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), NFC technology, and chips, infrared, and other wireless media. The term computer readable media as used herein may include both computer storage media and communication media.

As stated above, a number of program modules and data files may be stored in system memory 604, including operating system 605. While executing on processing unit 602, programming modules 606 (e.g. program module 607) may perform processes including, for example, one or more of the stages of a process. The aforementioned processes are examples, and processing unit 602 may perform other processes. Other programming modules that may be used in accordance with embodiments of the present invention may include electronic mail and contacts applications, word processing applications, spreadsheet applications, database applications, slide presentation applications, drawing or computer-aided application programs, etc.

Generally, consistent with embodiments of the invention, program modules may include routines, programs, components, data structures, and other types of structures that may perform particular tasks or that may implement particular abstract data types. Moreover, embodiments of the invention may be practiced with other computer system configurations, including hand-held devices, multiprocessor systems, microprocessor-based or programmable consumer electronics, minicomputers, mainframe computers, and the like. Embodiments of the invention may also be practiced in distributed computing environments where tasks are performed by remote processing devices that are linked through a communications network. In a distributed computing environment, program modules may be located in both local and remote memory storage devices.

Furthermore, embodiments of the invention may be practiced in an electrical circuit comprising discrete electronic elements, packaged or integrated electronic chips containing logic gates, a circuit utilizing a microprocessor, or on a single chip (such as a System on Chip) containing electronic elements or microprocessors. Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the invention have been described, other embodiments may exist. Furthermore, although embodiments of the present invention have been described as being associated with data stored in memory and other storage mediums, data can also be stored on or read from other types of computer-readable media, such as secondary storage devices, like hard disks, floppy disks, or a CD-ROM, or other forms of RAM or ROM. Further, the disclosed methods' stages may be modified in any manner, including by reordering stages and/or inserting or deleting stages, without departing from the invention.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

We claim:

1. A system, over a communications network, for providing media comprising:
a provider tag, the provider tag configured to transmit the provider tag signal having a provider unique identifier;
a provider object for housing the provider tag;
a database for storing a provider record for each of a plurality of providers;
a memory; and,
a processor configured for:
providing, to a provider computing device, a provider interface for receiving a plurality of provider data, wherein the plurality of provider data includes at least a unique provider identifier associated with the provider;
receiving, from the provider computing device, the plurality of provider data;
creating the provider record for each of the plurality of providers;
storing the plurality of provider data in its associated provider record;
receiving, from the provider computing device, provider informative subject data on a subject;
storing, in the provider record the provider tag identifier associated with the provider tag;
receiving, from a user computing device, a user request for provider informative subject data, wherein the user request for provider informative subject data is automatically transmitted after the user computing device detects the provider tag signal having the provider unique identifier;
determining the provider record associated with the provider tag identifier received from the user computing device; and,
providing, over the communications network, to a graphical user interface of the user computing device, at least one media content associated with the provider informative subject data.

2. The system of claim 1, wherein the at least one media content comprises a personalized media associated with the user computing device.

3. The system of claim 1, wherein the provider object comprises at least a business card, a first surface associated with at least one of a memorial wall, a memorial bench, a picture frame, a fountain, jewelry, bracelet, pendent, a memorial furniture piece, and a memento of a loved individual configured to house the provider tag.

4. The system of claim 1, wherein the at least one media content associated with the provider informative subject data is displayed on the user computing device.

5. The system of claim 1, wherein the at least one media content associated with the provider informative subject data is displayed on an interface on an auxiliary computing device configured within a certain proximity to user computing device.

6. The system of claim 1, wherein the processor is further configured for:
providing, based on an interaction with the provider object, the graphical user interface; wherein the graphical user interface is configured to continuously receive a plurality of real-time inputs associated with at least the provider data.

7. The system of claim 1, wherein the provider tag comprises a near field communication (NFC) tag.

8. The system of claim 2, wherein the processor is configured to display a graphical representation of an entertaining experience displaying the at least one media content comprising the personalized media.

9. A method for providing personalized media via a communications network comprising:
providing, to a provider computing device, a provider interface for receiving a plurality of provider data, wherein the provider data includes at least a unique provider identifier associated with the provider;
receiving, from the provider computing device, the plurality of provider data;
creating the provider record configured to be stored in a provider record database;
storing the provider data in its associated provider record;
receiving, from the provider computing device, provider informative subject data on a subject;
storing, in the provider record, the unique provider identifier; wherein the unique provider identifier is associated with a provider tag configured to transmit a provider tag signal;
providing, to a user computing device, a user interface for receiving a plurality of user data, wherein the user computing device is configured to detect the provider tag signal when the user computing device is within a predetermined proximity of the provider tag;
receiving, from the user computing device, the plurality of user data associated with the user;
creating a user record;
storing, in an attached database, the user data associated with the user in the user record;
receiving, from the user computing device, a user request for provider informative subject data, wherein the user request for provider informative subject data is automatically transmitted after the user computing device detects the provider tag signal having the provider unique identifier;
determining the provider record associated with the provider unique identifier received from the user computing device; and,
generating at least one personalized media content based on the plurality of provider data and at least one of the plurality of user data and the provider informative subject data;
providing, over the communications network, to a graphical user interface proximate with the user, the at least one personalized media content.

10. A method for providing media comprising:
providing, to a provider computing device, a provider interface for receiving a plurality of provider data, wherein the provider data includes at least a unique provider identifier associated with the provider;
receiving, from the provider computing device, the plurality of provider data;
creating the provider record configured to be stored in a provider record database;
storing the provider data in its associated provider record;
receiving, from the provider computing device, provider informative subject data on a subject;
storing, in the provider record, the unique provider identifier; wherein the unique provider identifier is associated with a provider tag configured to transmit the provider tag signal;
detecting, via a user computing device, the provider tag signal when the user computing device is within a predetermined proximity of the provider tag;
receiving, from the user computing device, a user request for provider informative subject data, wherein the user request for provider informative subject data is automatically transmitted after the user computing device detects the provider tag signal having the provider unique identifier;
determining the provider record associated with the provider unique identifier received from the user computing device; and,
providing, over a communications network, to a graphical user interface proximate with the user, at least one media content associated with the provider informative subject data.

11. The method of claim 10, wherein the at least one media content comprises a personalized media associated with the user computing device.

12. The method of claim 10, wherein the provider object comprises at least a business card, a first surface associated with at least one of a memorial wall, a memorial bench, a picture frame, a fountain, jewelry, bracelet, pendent, a memorial furniture piece, and a memento of a loved individual configured to house the provider tag.

13. The method of claim 10, wherein the at least one media content associated with the provider informative subject data is displayed on the user computing device.

14. The method of claim 10, wherein the at least one media content associated with the provider informative subject data is displayed on an interface on an auxiliary computing device configured within a certain proximity to user computing device.

15. The method of claim 10, wherein the processor is further configured for:
providing, based on an interaction with the provider object, the graphical user interface; wherein the graphical user interface is configured to continuously receive a plurality of real-time inputs associated with at least the provider data.

16. The method of claim 10, wherein the provider tag comprises a near field communication (NFC) tag.

17. The method of claim 11, wherein the processor is configured to display a graphical representation of an entertaining experience displaying the at least one media content comprising the personalized media.
